(19) United States
(12) Patent Application Publication
(10) Pub. No.: US 2006/0041629 A1
(43) Pub. Date: Feb. 23, 2006

(54) Magnification of incoming and outgoing messages in the user interface of instant messaging and other digital communication services

(76) Inventor: Luigi Lira, Costa Mesa, CA (US)

Correspondence Address: Luigi Lira, 2973 Harbor Blvd #198, Costa Mesa, CA, 92626, US

(21) Appl. No.: 11/174,934

(22) Filed: Jul. 5, 2005

Related U.S. Application Data
(60) Provisional application No. 60/603,714, filed on Aug. 23, 2004.
(60) Provisional application No. 60/609,079, filed on Sep. 10, 2004.
(60) Provisional application No. 60/674,621, filed on Apr. 25, 2005.

(51) Int. Cl. G06F 15/16

(52) U.S. Cl. 709/206

(57) ABSTRACT

The invention relates to instant messaging communications. More particularly, the invention relates to the magnification, or set in evidence, of incoming and/or outgoing messages. Typically only the at least one latest exchanged messages is magnified. A messages ends being displayed in a magnified fashion at the occurrence of a predetermined event, such as, a new message is exchanged, the user start or continue to compose an outgoing message, or the user selects to dismiss the magnification. Typically, once a message ends being displayed in a magnified fashion it begins being displayed in a normal fashion, e.g. in the transcript area of the session window in its sender selected, or recipient enforced, font, size, and style.

### CROSS REFERENCE TO RELATED APPLICATIONS

This application claims priority to U.S. provisional patent application Ser. No. 60/603,714, filed 23 Aug. 2004, 60/609,079, filed 10 Sep. 2004, and 60/674,621, filed 25 Apr. 2005, which applications are incorporated herein in their entirety by this reference thereto.

This application also incorporates herein in its entirety by this reference thereto disclosure document no. 556,080, which was received at the U.S. Patent Office on 30 Jun. 2004.

This application share common provisionals (U.S. provisional patent application Ser. No. 60/603,714, filed 23 Aug. 2004, and 60/609,079, filed 10 Sep. 2004) and common disclosure document (no. 556,080, which was received at the U.S. Patent Office on 30 Jun. 2004) with U.S. non-provisional patent application Ser. No. 11/137,174, filed May 24, 2005.

### BACKGROUND OF THE INVENTION

1. Technical Field

The invention relates to instant messaging communications. More particularly, the invention relates to the magnification, or set in evidence, of incoming and/or outgoing messages. Typically only the at least one latest exchanged messages is magnified. A messages ends being displayed in a magnified fashion at the occurrence of a predetermined event, such as, a new message is exchanged, the recipient start or continue to compose an outgoing message, or the recipient selects to dismiss the magnification. Typically, once a message ends being displayed in a magnified fashion it begins being displayed in a normal fashion, e.g. in the transcript area of the session window in its sender selected, or recipient enforced, font, size, and style.

2. Description of the Prior Art

An instant message (IM) is a form of electronic communication between users of a computer network in which a message is delivered instantly and without the recipient having to access an e-mail program or otherwise check for messages. An instant message appears essentially as soon as the message sender clicks the send button, subject to any time or propagation delays the message may have encountered on the network. In comparison to most e-mail applications, instant messaging enables users to communicate with each other in a more dynamic, interactive, and entertaining manner.

FIG. 4A shows a simplified session window 100 that contains the user interface basic elements. These basic elements are featured in the user interface of the major IM services, such as those from America Online, Inc., Yahoo, Inc., and Microsoft, Inc. The basic elements of the user interface are a transcript area 101 where the messages from all the users involved in the communication are displayed in their chronological order as they are sent; a message composition area 102 where the user inputs the message to send to the other parties involved in the communication; and a send button 103 that the user selects when ready to send the message. Typically, the user interface also contains many other elements, for example, a control to select the font of the message, a control to select the font size of the message, and a control to select the color of the message text, among others. Those extra elements are not relevant for the herein description.

For the purpose of illustrating an IM communication, FIG. 4B shows a session window 100 where two users have exchanged a few messages. The message address field 111 shows which user sent the message. The currently available IM services are able to send text content 112 formatted with font, size, color, and other attributes chosen by the sender. They are also able to send emoticon graphic content 113. So-called emoticons are small to medium sized images or graphics, typically depicting cartoon-like smiling, winking, or sad faces. Emoticons are generally provided by the IM service itself, and are accessible to the sender by means of a user interface element, for example, a pop-up or a sub window. The currently available IM services are also able to send image content 114. The image is usually not provided by the service. The sender typically supplies it. In addition, currently available IM services are able to send data files that, being raw data, can contain any media and information.

FIG. 4C shows a more sophisticated session window 100 that contains two types of recently introduced user interface elements. The user interface elements are referred to as wallpapers 116a and 116b and avatars 117a and 117b. Both are described as user personalization items meant to enhance the user projected presence and personality. Both wallpapers and avatars are typically chosen by the sender on a per session or default basis and are typically displayed symmetrically, i.e. showing the same content at, or almost at, the same time, on both the sender's and recipient's client user interfaces for the whole length of the session. The avatar typically resembles a cartoon-like head of a fictional character, and it may be animated upon sender's input or autonomously upon input from the communication itself. In addition, during the animation they may rest, or they may move within the session window. Both wallpapers and avatars are persistent and are meant to enhance the entertainment of the communication by means of a persistent fictional projection, also called a proxy representation, of the sender on the recipient's client user interface.

FIG. 4D shows an example of a greeting card 119 displayed within a browser window 210 separated from the recipient's instant message window 100. Essentially, the instant message client issues a request to an Internet browser, e.g. Internet Explorer, to load and display a web page containing the greeting card. This prior art has several disadvantages. To name a few:

The greetings card is displayed within a separate window of an Internet browser, e.g. Internet Explorer. Such window is typically either placed centered on the screen or placed near the session window 100; only accidentally, i.e. unintentionally, such window may overlay the session window 100.

Greeting cards do not support artistic rendering of sender supplied text, e.g. an “electric” effect, a “glowing” effect, a “3D” effect. Even though some greetings card may comprise some graphically integrated text, such text is part of the greetings card and it is unmodifiable. Greetings card technology allows for the sender to supply text, but greetings card technology currently on the market display such text small, static, monochromatic, having peripheral placement in relation to the greetings card, and without animation; being such user supplied text mostly in the role of caption to such greeting card

FIGS. 6A, 6B, and 6C depict the same prior art embodiment in three progressive time instances.

In FIG. 6A the recipient's client just received an incoming message 710, “Hello”. The message 710, “Hello”, is the latest message received by the recipient's client, and so far is also the only message exchanged. The message 710, “Hello”, is displayed in the transcript area 101 contained in the session window 100. In typical circumstances, the message 710, “Hello”, has not yet been read by the recipient.

Subsequently, in FIG. 6B the recipient's client just received a new incoming message 720, “How did it go at the meeting?”. The message 720, “How did it go at the meeting?”, is now the latest message received by the recipient's client.

The message 710, “Hello”, is now no more the latest exchanged message. In typical circumstances, the message 720, “How did it go at the meeting?”, has not yet been read by the recipient, while the message 710, “Hello”, already has.

Subsequently again, in FIG. 6C the recipient's client just received a new incoming message 730, “Should we meet for lunch?”. The message 730, “Should we meet for lunch?”, is now the latest message received by the recipient's client.

Both the message 710, “Hello”, and the message 720, “How did it go at the meeting?”, are no more the latest exchanged messages. In typical circumstances, the message 730, “Should we meet for lunch?”, has not yet been read by the recipient, while both the message 720, “How did it go at the meeting?”, and the message 710, “Hello”, already have.

As evident in FIGS. 6A, 6B, and 6C the latest exchanged message, that in typical circumstances has not yet been read, is displayed in the same fashion as the priorly, i.e. non-latest, exchanged messages, that in typical circumstances already have been read.

The disadvantages of such an approach are several. To name a few:
In order to maintain visible in the transcript area of a medium-sized session window a reasonably long queue of messages, the messages have to be displayed in medium to small size. This is not optimal for people with lesser eye vision that have to strain their eyes to read medium to small-sized text.
   To display all messages in a large text size reduces the length of the queue of messages visible in the transcript area of a medium-sized session window. Consequently, when the user's attention goes back to the IM session from other tasks, the reduced length of the queue of messages visible in the transcript area prevents the user from quickly glimpsing through the last few messages of the session, thus preventing the user from instantly recalling the point of communication.
   To display all messages in a large text size requires the recipient to maintain a large-sized session window for the sole purpose of viewing the large text size messages, using screen space that is otherwise used for other session windows or windows from other applications.

### SUMMARY OF THE INVENTION

The herein described invention recognizes the prior art instant messaging embodiment limitations and introduces a solution to those limitations. It does so by displaying the latest at least one message in an alternative fashion than priorly, i.e. non-latest, exchanged messages. While priorly exchanged messages are displayed in a regular fashion, i.e. as prior arts do, the latest at least one message is displayed magnified and/or set in evidence.

In the preferred embodiment, only the at least one latest exchanged messages is magnified. A messages ends being displayed in a magnified fashion at the occurrence of a predetermined event, such as, a new message is exchanged, the recipient start or continue to compose an outgoing message, or the recipient selects to dismiss the magnification. Typically, once a message ends being displayed in a magnified fashion it begins being displayed in a normal fashion, e.g. in the transcript area of the session window in its sender selected, or recipient enforced, font, size, and style. In alternate embodiments, the at least one latest exchanged messages is concurrently displayed magnified and displayed in a normal fashion.

### BRIEF DESCRIPTION OF THE DRAWINGS

FIG. 1 provides an example of a message displayed in a magnified fashion within a translucent window overlaying a session window;

FIG. 2 provides a general overview of a computer communication network;

FIG. 3A provides an example of a client user interface for a desktop computer;

FIG. 3B provides an example of a client user interface for a PDA;

FIG. 3C provides an example of a client user interface for an advanced cellular phone;

FIG. 4A through 4E provide examples of prior arts;

FIG. 5 provides a flow-chart of message displayed in a magnified fashion sequence;

FIGS. 6A, 6B, and 6C provide an example of a prior art embodiment in progressive time instances;

FIGS. 7A through 11C provide an example of an embodiment in progressive time instances;

FIGS. 12A through 14C provide an example of an embodiment displaying messages of different length;

FIGS. 15A through 17C provide an example of an embodiment in progressive time instances animating the presentation of a message;

FIGS. 18A and 18B provide examples of magnification bordered by a graphic processing alteration; and

FIGS. 19A, 19B, and 19C provide an example of an embodiment displaying the generation of a message at different levels of magnification.

### DETAILED DESCRIPTION OF THE INVENTION

In the preferred embodiment, at least one latest exchanged message is displayed in a magnified fashion. A messages ends being displayed in a magnified fashion at the occurrence of a predetermined event, such as, a new message is exchanged, the recipient start or continue to compose an outgoing message, or the recipient selects to dismiss the magnification. Typically, once a message ends being displayed in a magnified fashion it begins being displayed in a normal fashion, e.g. in the transcript area of the session window in its sender selected, or recipient enforced, font, size, and style. In alternate embodiments, the at least one latest exchanged messages is concurrently displayed magnified and displayed in a normal fashion.

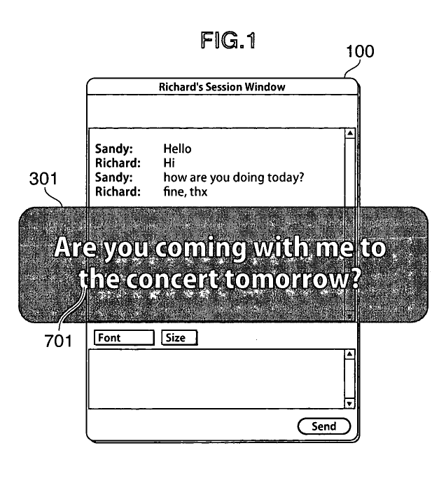

For an embodiment, FIG. 1 depicts a message 701, “Are you coming with me to the concert tomorrow?”, displayed in a magnified fashion, i.e. a “magnification”, within a translucent window 301 that overlays the recipient's session window 100.

The following description defines a typical instant message environment.

Typically, instant message (IM) communications involve an instantaneous or nearly instantaneous communication between two or more users, where each user is able to transmit, receive, and display communicated information. Additionally, although IM communications may occur in the absence of online presence information, IM communication generally involves the display and perception of online presence information regarding other selected users (“buddies”.) After a communication session is established or authentication is performed, the IM communications may be machine-to-machine communications that occur without intervention by, or communication through, an instant messaging server. Examples of IM communications exist over AIM (America Online Instant Messenger), AOL (America Online) buddy list and Instant Messenger, Yahoo Messenger, MSN Messenger, and ICQ, among others.

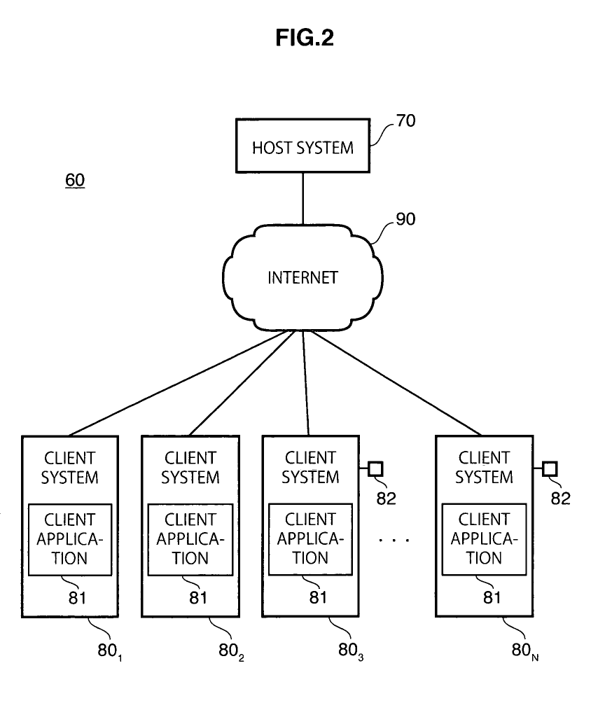

FIG. 2 illustrates a general overview of a computer communication network 60 including a host system 70, i.e. an IM server. In computer network 60, client systems 80.sub.1 to 80.sub.N, i.e. IM client systems, are coupled through the Internet 90, or other communication network, to the host system 70. Only one host system 70 is shown, but it is understood that more than one host system can be used and that other servers providing additional functionality may also be interconnected in network 60 directly, over a LAN or a WAN, or over the Internet. Several elements in the system shown in FIG. 2 are conventional, well-known elements that need not be explained in detail here.

The herein described invention is suitable for use with the Internet, which for purposes of the discussion herein refers to a specific global inter-network of networks. However, it should be understood that other networks can be used instead of the Internet, such as an intranet, an extranet, a virtual private network (VPN), a wireless network, e.g. GPRS, an ATM network, non-TCP/IP based network, or the like.

According to one embodiment, the host system 70 and all of its components are operator-configurable using computer code run using a central processing unit. Computer code for operating and configuring the host system 70 is preferably stored on a hard disk, but the entire program code, or portions thereof, may also be stored in any other memory device, such as a ROM or RAM, or provided program code, such as a compact disk medium, a floppy disk, or the like.

Each client system 80, for example, could be a desktop personal computer, workstation, cellular telephone, personal digital assistant (PDA), music or video player, laptop, or any other computing device capable of interfacing directly or indirectly to the Internet. Each client system 80 also typically includes one or more user interface devices 82, such as a keyboard, a mouse, touch-screen, pen or the like, for interacting with a client 81, i.e. an IM client application, by means of a client user interface, i.e. a graphical user interface provided by client itself, and for interacting with any other application, program, and software or similar entity by means of their respective user interfaces.

An example of a client 81 is a software application loaded on the client system 80 for commanding and directing communications enabled by the client system 80. Other examples include a program, a piece of code, an instruction, a firmware, an embedded capability, a device, a computer, a computer system, or a combination of these for independently or collectively instructing the client system 80 to interact with the host system 70 and operate as described. The client 81 may be embodied permanently or temporarily in any type of machine, component, physical or virtual equipment, storage medium, or propagated signal capable of providing instructions to the client system 80.

A client 81 could also be software which primary use is not for instant messaging, but nevertheless, has full or partial instant messaging capabilities, for example, a multipurpose communication software, e.g. America Online Inc., AOL 9.0, IRC software, word processing and spreadsheet applications having networking capabilities, web browsers, e.g. Mozilla or Netscape Communicator, web browsers in conjunction with instruction received from a web site, e.g. AIM Express, and video, audio, or multimedia communication software.

To access the host system 70 to begin an IM session in the implementation of FIG. 2, the client system 80.sub.1 establishes a connection to the host system 70. Once the connection to the host system 70 has been established, the client system 80.sub.1 may directly or indirectly transmit data to, and access content from, the host system 70. By accessing the host system 70, a user can use the client 81 to view whether particular users (“buddies”) are online, exchange IMs with particular buddies, participate in group chat rooms, trade files such as pictures, invitations or documents, and find other buddies with similar interests. The client system 80.sub.2 may be similarly manipulated to establish contemporaneous connection with the host system 70. In certain system embodiments, the client system 80 may act as a substitutive equivalent of the host system 70 to other client systems 80, e.g. a Gnutella-like or Limewire-like decentralized P2P communication network.

Once connectivity is established, a user who is using the client system 80.sub.1 may view whether a second user operating, for example, the client system 80.sub.2 is online, and typically may view whether the second user is able to receive IMs. If the second user is online, the user operating the client system 80.sub.1 may exchange IMs with the second user. In one implementation, the IMs sent between the client system 80.sub.1 and the client system 80.sub.2 are routed through the host system 70. In another implementation, the IMs sent between the client system 80.sub.1 and the client system 80.sub.2 are routed through a third party server (not shown), and, in some cases, are also routed through the host system 70. In yet another implementation, the IMs are sent directly between the client system 80.sub.1 and the client system 80.sub.2.

The client user interface is the graphic user interface generated by the client 81 to display to the user information related, for the most part, to the IM communication.

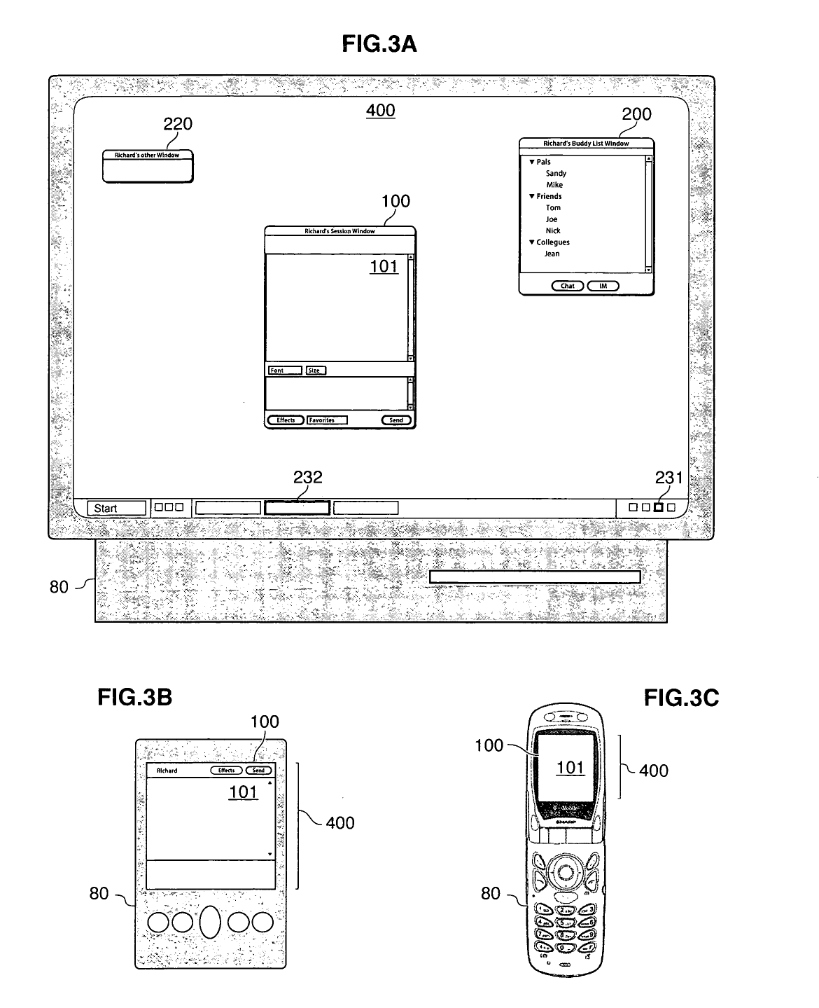

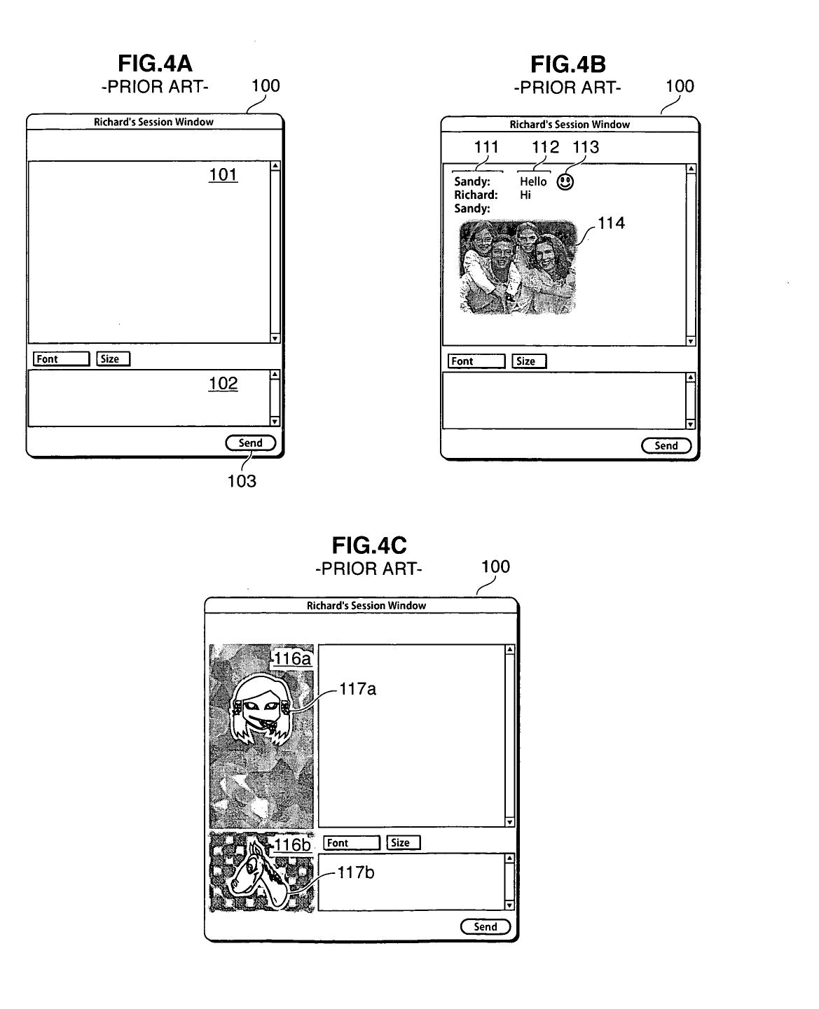

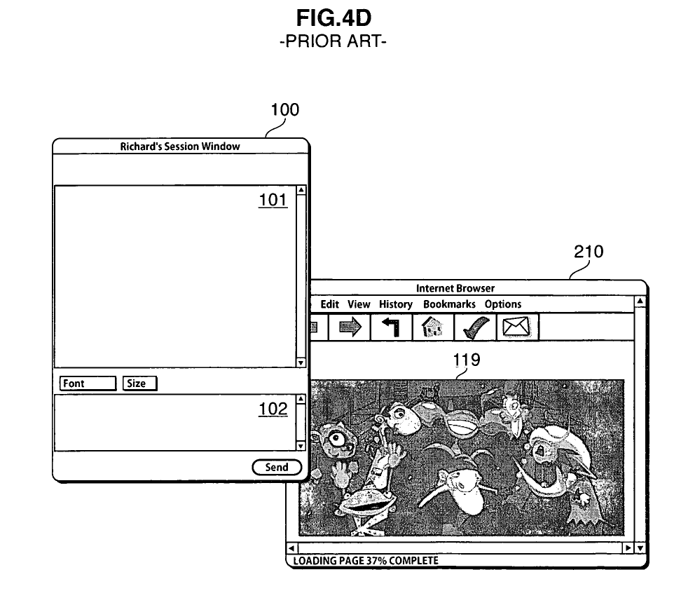

Referring to FIG. 3A, in one embodiment where the client system 80 is, for example, a desktop computer, the client user interface is usually constituted by one or more session windows 100, a buddy list window 200, and often, other miscellaneous windows, e.g. window 220 all displayed on a screen 400. The client user interface also usually comprises one, or more, of the icon 231 and window locator 232 related to the client 81 of FIG. 2.

Referring to FIG. 3B, in one embodiment where the client system 80 is, for example, a PDA, the visible portion of the client user interface usually alternates, due to the small size of the screen 400, between a session windows 100, a buddy list window, and other miscellaneous windows.

Referring to FIG. 3C, in one embodiment where the client system 80 is, for example, an advanced cellular phone, the visible portion of the client user interface usually alternates, due to the small size of the screen 400, between a session windows 100, a buddy list window, and other miscellaneous windows. On some advanced cellular phones the transcript area 101 is the only visible element of the user interface for the session windows 100 and such transcript area 101 covers the entire screen 400. On other advanced cellular phones, the user interface may resemble and be more similar to the user interface of a PDA or of a portable computer.

Referring to FIG. 3A, FIG. 3B, and FIG. 3C the session window 100 typically contains, among other user interface items, the transcript area 101. The transcript area contains the visible portion of the transcript of the IMs that have been exchanged between the user of the client system 80 and the other users participating in the IM session. Hence, the terms transcript and transcript area are herein used.

To clarify, the client system is usually a hardware entity. The client is usually a software entity having a client user interface comprising the session window and often other windows, e.g. a buddy list window and frequently other session windows. The session window typically comprises the transcript area, where the user can see the IMs exchanged during the session. The sender and the recipient are usually human beings, although sometimes they can be hardware or software automated processes. A user is alternately sender or recipient depending whether he is sending an IM or receiving one. Typically, a user swaps between the roles of sender and recipient every few seconds.

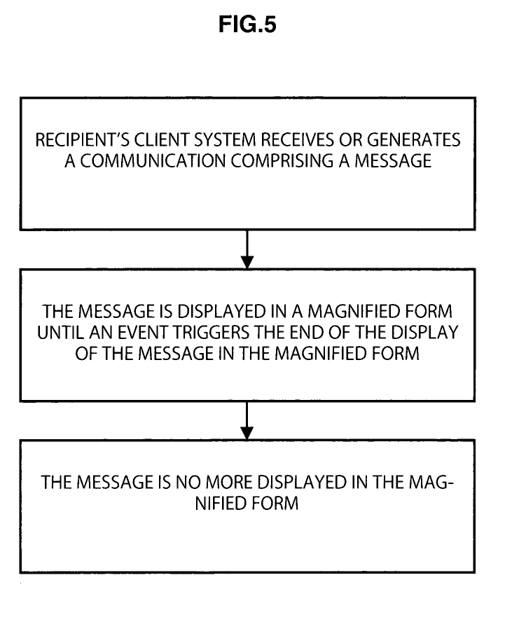

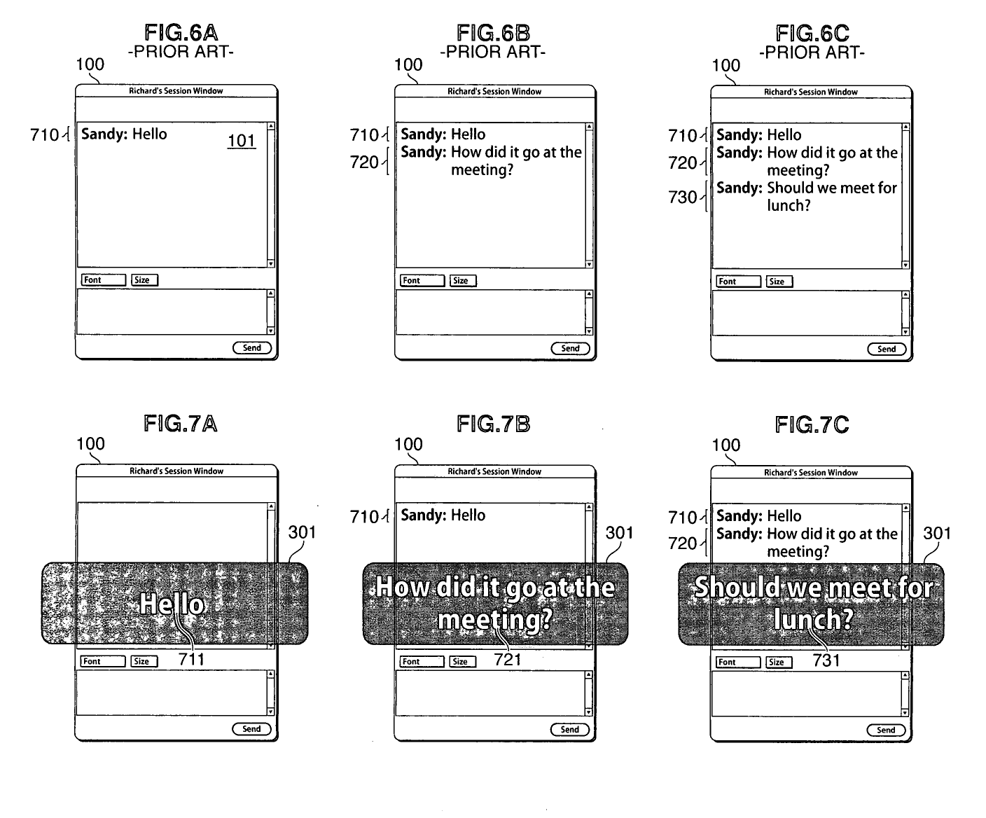

FIG. 5 shows, for the preferred embodiment, the flow-chart of a sequence of message displayed in a magnified fashion.

FIGS. 7A, 7B, and 7C depict an embodiment in three progressive time instances.

In FIG. 7A the recipient's client just received an incoming message 711, “Hello”. The message 711, “Hello”, is the latest message received by the recipient's client, and so far is also the only message exchanged. The message 711, “Hello”, is displayed in a magnified fashion within a translucent window 301 that overlays the recipient's session window 100. In typical circumstances, the message 711, “Hello”, has not yet been read by the recipient.

Subsequently, in FIG. 7B the recipient's client just received a new incoming message 721, “How did it go at the meeting?”. The message 721, “How did it go at the meeting?”, is now the latest message received by the recipient's client. The message 710, “Hello”, is now no more the latest exchanged message. The reception of the message 721, “How did it go at the meeting?”, is an event that triggers the dismissal of the magnification of the prior message. The message 721, “How did it go at the meeting?”, is displayed in a magnified fashion within a translucent window 301 that overlays the recipient's session window 100. In typical circumstances, the message 721, “How did it go at the meeting?”, has not yet been read by the recipient, while the message 710, “Hello”, already has.

Subsequently again, in FIG. 7C the recipient's client just received a new incoming message 731, “Should we meet for lunch?”. The message 731, “Should we meet for lunch?”, is now the latest message received by the recipient's client. Both the message 710, “Hello”, and the message 720, “How did it go at the meeting?”, are no more the latest exchanged messages. The reception of the message 731, “Should we meet for lunch?”, is an event that triggers the dismissal of the magnification of the prior message. The message 731, “Should we meet for lunch?”, is displayed in a magnified fashion within a translucent window 301 that overlays the recipient's session window 100. In typical circumstances, the message 731, “Should we meet for lunch?”, has not yet been read by the recipient, while both the message 720, “How did it go at the meeting?”, and the message 710, “Hello”, already have.

As evident in FIGS. 7A, 7B, and 7C the latest exchanged message, that in typical circumstances has not yet been read, is magnified, while the priorly, i.e. non-latest, exchanged messages, that in typical circumstances already have been read, are displayed in a normal fashion, e.g. in the transcript area of the session window in its sender selected, or recipient enforced, font, size, and style.

The translucent window 301 may be fixed in size or expand or shrink to accommodate messages of different sizes. The size of the text of the message may be fixed and be the same regardless of the length of the message or may increase or decrease inversely proportionally to the length of the message, i.e. short messages are displayed in a larger text size than the text size of long messages. The translucent window 301 may disappear from sight when no messages are magnified.

A magnified display may, for example, comprise the message along with an identifier of the sender, time stamp, incoming or outgoing indication, or indication of sender's activity.

In an embodiment, the recipient's client may enable the recipient to select a priorly, i.e. non-latest, exchanged messages for magnification display or re-display.

In an embodiment, the recipient's client may concurrently display the same message both in a magnified fashion and a regular fashion.

In an embodiment, the dismissal of the magnification of a message, e.g. the message is no more displayed magnified, may be triggered by an event, such as, a new message is exchanged, the recipient start or continue to compose an outgoing message, or the recipient selects to dismiss the magnification.

The recipient's client may enable the recipient to customize, e.g. set or reset, the list of events that trigger a dismissal, for example, per message, per message classification, per IM session, per sender, or always.

In an embodiment, for example, only the incoming messages are displayed in a magnified fashion, only the outgoing messages are displayed in a magnified fashion, or both.

The recipient's client may enable the recipient to customize, e.g. set or reset, the magnification of incoming and/or outgoing messages, for example, per message, per message classification, per IM session, per sender, or always.

In an embodiment, only certain types of messages are displayed in a magnified fashion. For example, a message matching a preset classification, a message shorter, equal, or longer of a preset length, and/or a message comprising preset keywords, e.g. “yes”, “no”, or an interjection.

The recipient's client may enable the recipient to customize, e.g. set or reset, the rules for the selection of messages to be magnified, for example, per message, per message classification, per IM session, per sender, or always.

In an embodiment, the type of magnification, artwork display, and/or animation may be selected upon, for example, the content of a message. For example, a message content matching a preset classification, a message shorter, equal, or longer of a preset length, and/or a message comprising preset keywords, e.g. “yes”, “no”, or an interjection.

In an embodiment, the type of magnification, artwork display, and/or animation may be selected by the sender of the message. For example, a sender may select to have his messages be presented with a particular type of magnification, artwork display, and/or animation by recipient clients that are set or preset to magnify incoming messages.

The recipient's client may enable the recipient to customize, e.g. set or reset, rules for the magnification, artwork display, and/or animation, for example, per message, per message classification, per IM session, per sender, or always.

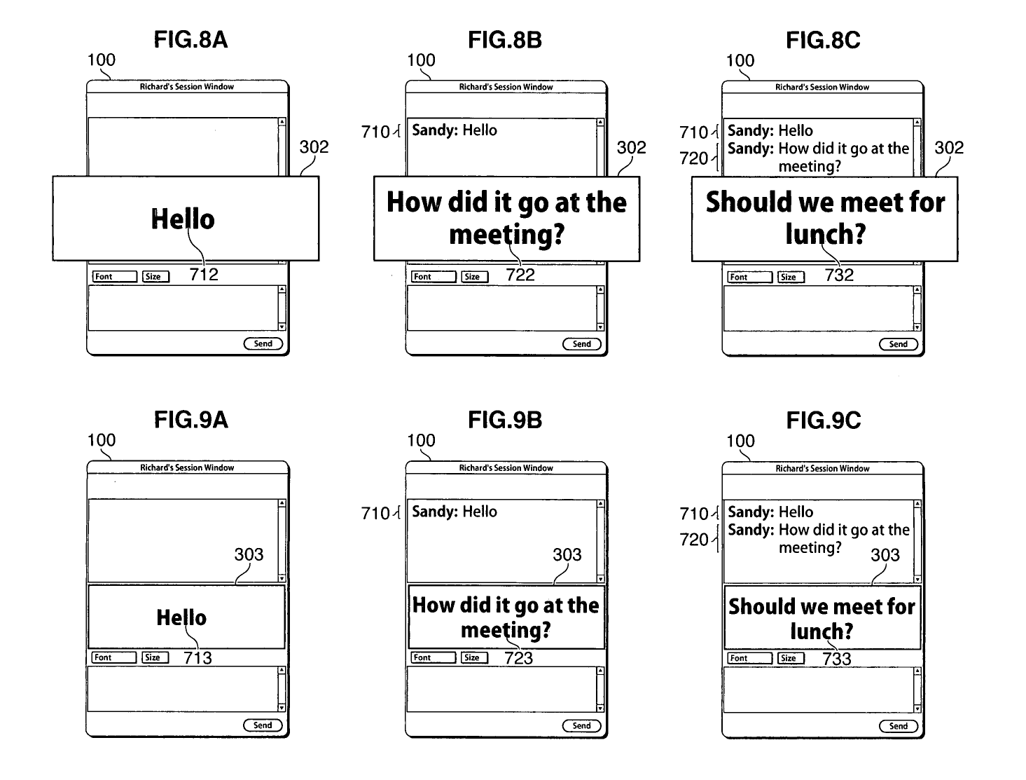

FIGS. 8A, 8B, and 8C depict an embodiment in three progressive time instances. The embodiment depicted in FIGS. 8A, 8B, and 8C is similar to the embodiment depicted in FIGS. 7A, 7B, and 7C. The only difference in FIGS. 8A, 8B, and 8C is that the messages 712, “Hello”, 722, “How did it go at the meeting?”, and 732, “Should we meet for lunch?”, are displayed within an opaque window 302 that overlays the recipient's session window 100. The messages 710 and 720 are priorly, i.e. non-latest, exchanged messages and are displayed in a normal fashion.

The opaque window 302 may be fixed in size or expand or shrink to accommodate messages of different sizes. The opaque window 302 may disappear from sight when no messages are magnified.

FIGS. 9A, 9B, and 9C depict an embodiment in three progressive time instances. The embodiment depicted in FIGS. 9A, 9B, and 9C is similar to the embodiment depicted in FIGS. 7A, 7B, and 7C. The only difference in FIGS. 9A, 9B, and 9C is that the messages 713, “Hello”, 723, “How did it go at the meeting?”, and 733, “Should we meet for lunch?”, are displayed within an area 303 located in the recipient's session window 100. The messages 710 and 720 are priorly, i.e. non-latest, exchanged messages and are displayed in a normal fashion.

The area 303 may be fixed in size or expand or shrink to accommodate messages of different sizes. The area 303 may collapse when no messages are magnified.

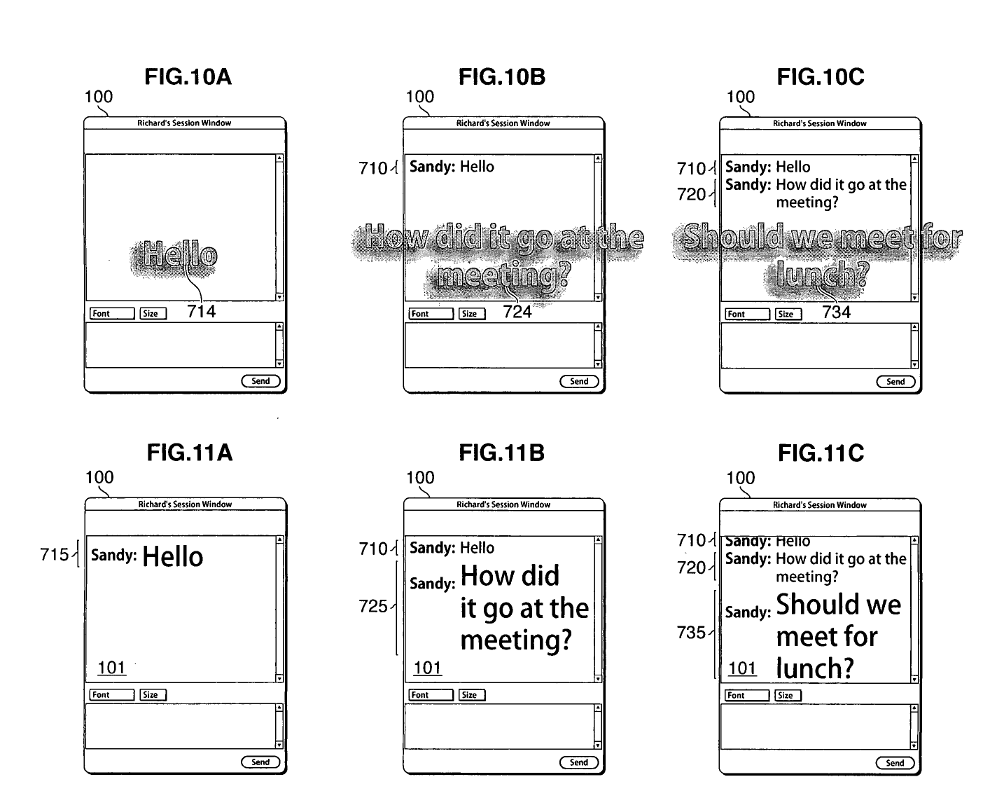

FIGS. 10A, 10B, and 10C depict an embodiment in three progressive time instances. The embodiment depicted in FIGS. 10A, 10B, and 10C is similar to the embodiment depicted in FIGS. 7A, 7B, and 7C. The only difference in FIGS. 10A, 10B, and 10C is that the messages 714, “Hello”, 724, “How did it go at the meeting?”, and 734, “Should we meet for lunch?”, are displayed unbound to any window and overlaid on the recipient's session window 100. The messages 710 and 720 are priorly, i.e. non-latest, exchanged messages and are displayed in a normal fashion.

FIGS. 11A, 11B, and 11C depict an embodiment in three progressive time instances. The embodiment depicted in FIGS. 11A, 11B, and 11C is similar to the embodiment depicted in FIGS. 7A, 7B, and 7C. The only difference in FIGS. 11A, 11B, and 11C is that the messages 715, “Hello”, 725, “How did it go at the meeting?”, and 735, “Should we meet for lunch?”, are displayed within the transcript area 101 of the recipient's session window 100. The magnified messages may be displayed following the rules and constrains of an-magnified messages displayed within the transcript area 101 at exclusion of, for example, the size of the text being larger for magnified messages. The messages 710 and 720 are priorly, i.e. non-latest, exchanged messages and are displayed in a normal fashion.

An embodiment may, for example, scroll upward, or otherwise reposition, the display of the exchanged messages to prevent the exchanged messages from being obscured, i.e. to be no more visible to the recipient, by the display of a magnified message.

The recipient's client may enable the recipient to customize, e.g. set or reset, the display of a magnified message, for example, per message, per message classification, per IM session, per sender, or always.

In the preferred embodiment, the size of the text of a magnified message may be fixed and be the same regardless of the length of the message or may increase or decrease inversely proportionally to the length of the message, i.e. short messages are displayed in a larger text size than the text size of long messages. Artworks comprised in a magnified message may also be scaled, e.g. enlarged to match the increase in size of the text.

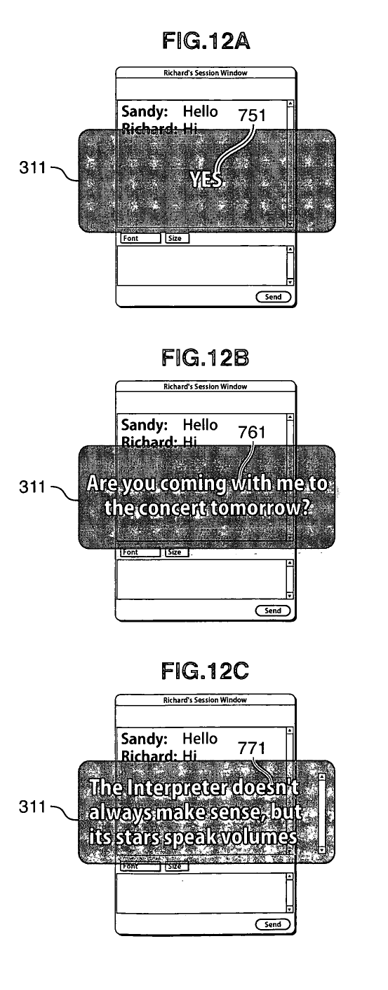

FIGS. 12A, 12B, and 12C provide an example of an embodiment displaying messages of different length. In FIG. 12A a short length message 751, “YES”, is magnified. In FIG. 12B a medium length message 761. “Are you coming with me to the concert tomorrow?” is magnified. In FIG. 12C a long length message 771. “The Interpreter doesn't always make sense, but its stars speak volumes, Joe Morgenstern write” is magnified. As it is noticeable, in this embodiment, both the size of the translucent window 311 and the text size used to display the messages 751, 761, and 771 remains constant regardless of the length of the message being magnified.

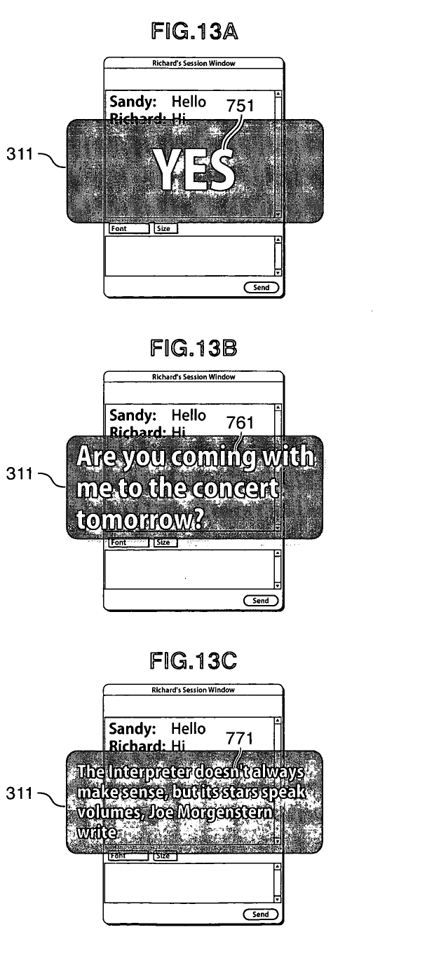

FIGS. 13A, 13B, and 13C provide an example of an embodiment displaying messages of different length. In FIG. 13A a short length message 751, “YES”, is magnified. In FIG. 13B a medium length message 761. “Are you coming with me to the concert tomorrow?” is magnified. In FIG. 13C a long length message 771. “The Interpreter doesn't always make sense, but its stars speak volumes, Joe Morgenstern write” is magnified. As it is noticeable, in this embodiment, the size of the translucent window 311 remains constant regardless of the length of the message being magnified, but the text size used to display the messages 751, 761, and 771 varies in function of the length of the message being magnified. Short length messages are magnified using a larger text size than the text size in which longer messages are magnified.

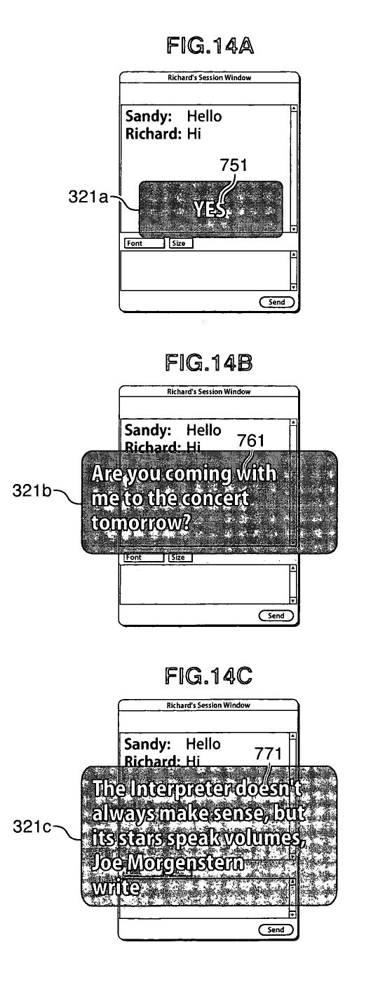

FIGS. 14A, 14B, and 14C provide an example of an embodiment displaying messages of different length. In FIG. 14A a short length message 751, “YES”, is magnified. In FIG. 14B a medium length message 761. “Are you coming with me to the concert tomorrow?” is magnified. In FIG. 14C a long length message 771. “The Interpreter doesn't always make sense, but its stars speak volumes, Joe Morgenstern write” is magnified. As it is noticeable, in this embodiment, the size of the translucent windows 321a, 321b, and 321c varies in function of the length of the message being magnified, but the text size used to display the messages 751, 761, and 771 remains constant regardless of the length of the message being magnified.

An embodiment may also provide a magnification strategy that is a mix between the magnification strategies exemplified in the FIGS. 12A through 14C.

The recipient's client may enable the recipient to customize, e.g. set or reset, the strategy used to display a magnified message, for example, per message, per message classification, per IM session, per sender, or always.

In an embodiment, the display of a magnified message may be an exact enlarged copy, e.g. a 150%, a 200%, or a 400% enlargement, of the same message display in a normal fashion. Also, a magnification may display, for example, enlarged, the same artworks and/or animations comprised in the same message displayed in a regular fashion.

In another embodiment, the display of a magnified message may be something different from exact enlarged copy, e.g. a 150%, a 200%, or a 400% enlargement, of the same message display in a normal fashion. For example, a magnified message may be displayed in a particular font or style used only for magnification display.

In an embodiment, a magnification may display artworks and/or animation not comprised in the same message displayed in a regular fashion. The artworks and/or animations may be set and/or altered by the recipient's client. The recipient's client may enable the recipient to customize, e.g. set or reset, some or all of the artworks and/or animations displayed in a magnified message, for example, per message, per message classification, per IM session, per sender, or always.

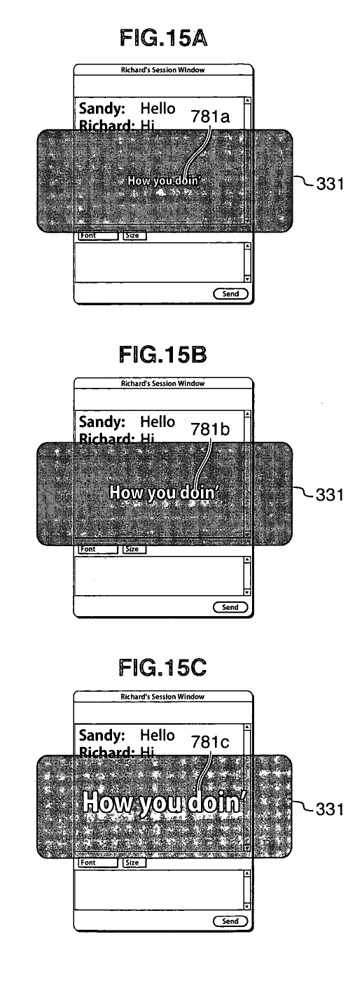

FIGS. 15A, 15B, and 15C depict an embodiment in three progressive time instances during an animation of a magnified message. In FIG. 15A the message 781a, “How you doin'”, just started its magnified display and is zooming out from the middle of the translucent window 331. In FIG. 15B the message 781b, “How you doin'”, is few tenth of a second from the start of its magnified display and is still zooming out from the middle of the translucent window 331. In FIG. 15C the message 781c, “How you doin'”, has finished to zoom out from the middle of the translucent window 331 and it is now in full view.

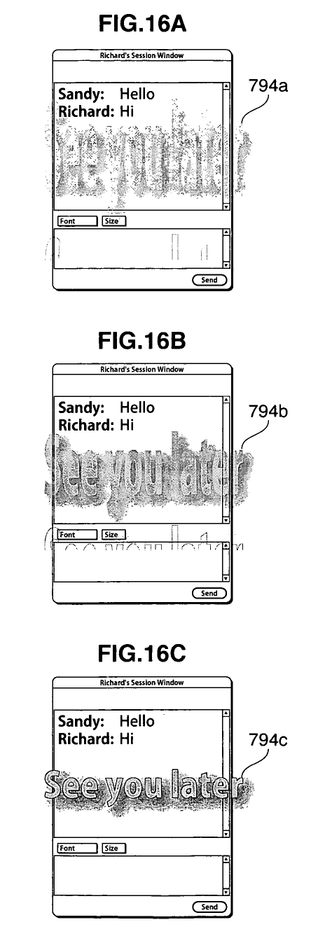

FIGS. 16A, 16B, and 16C depict an embodiment in three progressive time instances during an animation of a magnified message. In FIG. 16A the message 794a, “See you later”, just started its magnified display and is both fading in and shrinking in. In FIG. 16B the message 794b, “See you later”, is few tenth of a second from the start of its magnified display and is still both fading in and shrinking in. In FIG. 16C the message 794c, “See you later”, has finished both to fade in and shrink in and it is now in full view.

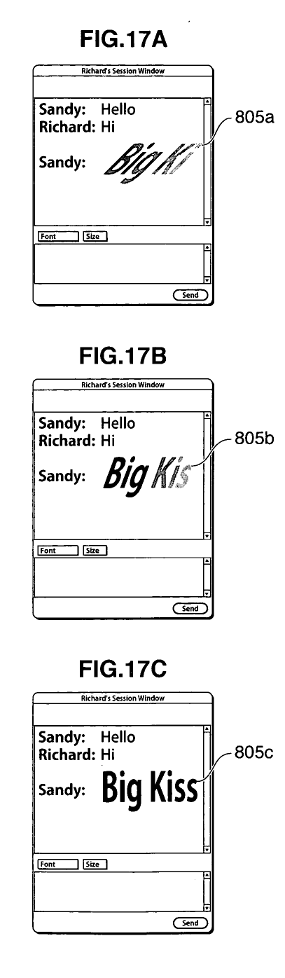

FIGS. 17A, 17B, and 17C depict an embodiment in three progressive time instances during an animation of a magnified message. In FIG. 17A the message 805a, “Big Kiss”, just started its magnified display and is both progressively fading in and shearing in. In FIG. 17B the message 805b, “Big Kiss”, is few tenth of a second from the start of its magnified display and is still both progressively fading in and shearing in. In FIG. 17C the message 805c, “Big Kiss”, has finished both to fade in and shear in and it is now in full view.

Other examples of animation displayed for a magnified message may be a typewriter effect, a letter, word, or whole message flip, twirl, drop, turn, etc.

In an embodiment, a sender may specify the preferred, for example, font, style, artworks, and animation to be used in a normal fashion message display and/or the preferred, for example, font, style, artworks, and animation to be used in a magnified fashion message display, which may differ from each others.

In an embodiment, the type of magnification, artwork display, and/or animation may be selected by the sender of the message. For example, a sender may select to have his messages be presented with a particular type of magnification, artwork display, and/or animation by recipient clients that are set or preset to magnify incoming messages.

To enhance the magnification impact, a graphic processing alteration may be applied to any user interface entity of the recipient's client and/or of any other entity displayed on the recipient client system screen, e.g. a ripple effect that looks like a drop splashing on a liquefied screen.

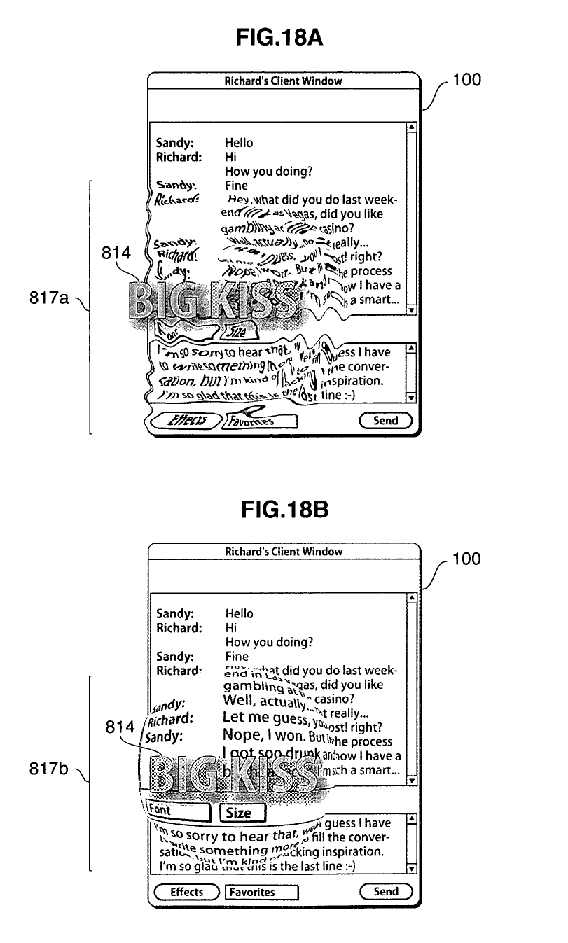

FIG. 18A depicts, for an embodiment, a message 814, “BIG KISS”, displayed in a magnified fashion that is surrounded by a ripple effect graphic processing alteration 817a. FIG. 18B depicts, for the preferred embodiment, a message 814, “BIG KISS”, displayed in a magnified fashion that is surrounded by a lens effect graphic processing alteration 817b.

In an embodiment, a recipient's client may enable the recipient to select to magnify the generation of outgoing messages. For example, the recipient's client may enlarge, e.g. a 150%, a 200%, or a 400% enlargement, the content of the composition area of a session window.

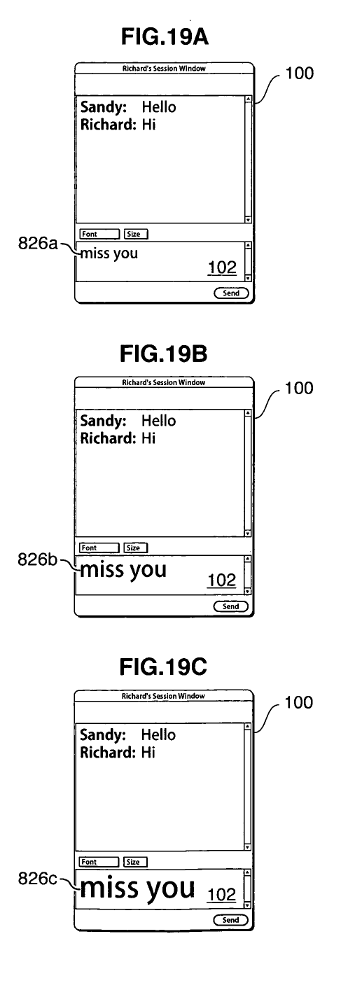

FIGS. 19A, 19B, and 19C provide an example of an embodiment displaying the content of the composition area 102 of a session window 100 magnified at different level of enlargement. In FIG. 19A, the message 826a, “miss you”, that is under generation, e.g. is being typed by the recipient, is displayed without magnification. In FIG. 19B, the message 826b, “miss you”, that is under generation, is displayed with an enlargement of 150%. In FIG. 19C, the message 826c, “miss you”, that is under generation, is displayed with an enlargement of 200%.

Although the invention has been described herein with reference to instant message clients having textual capabilities, one skilled in the art will readily appreciate that other types of clients may be substituted for those set forth herein without departing from the spirit and scope of this invention. For example, clients that may be substituted for instant message clients comprise streaming or non-streaming video clients, audio clients, and multimedia clients exchanging data between users, e.g. Apple Computer Inc., iChat AV or Yahoo Inc., Messenger Webcam, or receiving data from a broadcaster, e.g. RealNetworks, Inc., RealPlayer 10 or Microsoft Inc., Windows Media Player 9; IM clients having a user interface lacking the transcript area, which, for example, display IM messages on popup windows; applications that, de facto, act in part, or in totality, as an IM client; applications which primary purpose is not to enable a user-to-user, or multi-user, communication yet enable a partial or complete form of communication, e.g. a word processor having collaborative capabilities; clients which sole, or primary, purpose is to transmit and/or present overlaid messages; e-mail clients, e.g. Microsoft Inc., Outlook Express or Apple Computer Inc., Mail 1.3.9; e-mail and/or IM clients integrated in a software package, e.g. America Online Inc., AOL 9.0, International Business Machines Corp., Lotus Notes 6.5, or Microsoft Inc., Entourage 2004; WEB browsers, e.g. Microsoft Inc., Explorer 6, Netscape Inc., Navigator 7; and communication clients for cellular phones or PDAs.

The overlaid message artworks and texts depicted and commented in this description are merely examples. Any other artwork or text may be substituted for those set forth herein without altering the substance of this invention.

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. A computer implemented method, comprising the steps of:
providing an instant messaging client application user interface for an instant messaging communications session involving at least one instant message recipient and an instant message sender;
said at least one instant message recipient receiving a communication that comprises a message to be displayed to said at least one instant message recipient; and
said message being selected by said instant message sender;
wherein said message is presented magnified to said at least one instant message recipient until an event triggers the dismissal of said magnified display.

2. The method of claim 1, further comprising the step of:
said instant message recipient selecting to have messages being presented magnified;

3. The method of claim 1, said event is any of the following:
a preset timer;
a timer set by said instant message recipient;
an explicit request of termination from said instant message recipient;
an implicit request of termination from said instant message recipient; and
an incoming message.

4. The method of claim 1, said message is presented magnified is any of the following:
presented within a translucent user interface element transiently overlaying said instant messaging client application user interface;
presented within an opaque user interface element transiently overlaying said instant messaging client application user interface;
presented within an area of said instant messaging client application user interface;
presented overlaying said instant messaging client application user interface; and
presented within the transcript area of said instant messaging client application user interface.

5. The method of claim 1, said message is presented magnified overlaying said instant messaging client application user interface with an artistic elaboration applied to it.

6. The method of claim 5, said artistic elaboration is any of the following:
each letter having a white core surrounded by a red border;
each letter having a 3D appearance;
the text having a metallic appearance;
the text having water-like colors;
the text having an embossed appearance;
a dark shadow is displayed near the text;
at least part of the text is surrounded by an embossed blue border;
each letter having a green core surrounded by a yellow border;
each letter having a green core surrounded by a yellow border and at least part of the text is further surrounded by a black border; and
each letter having a green core surrounded by a yellow border, at least part of the text is further surrounded by a black border, and a dark shadow is displayed near at least part of the text.

7. The method of claim 1, said message being presented in altered shape.

8. The method of claim 7, said shape alteration is any of the following:
at least part of the message being warped;
at least part of the message being convoluted;
at least part of the message being stretched;
at least part of the message being rotated;
at least part of the message following a wave-like path;
at least part of the message having a reflex-like display along with its primary display; and
at least part of the message being slanted and enlarged toward the right to create a protruded 3D appearance.

9. The method of claim 1, said presentation comprises a transient graphic alteration of pre-existing user interface.

10. The method of claim 9, said transient graphic alteration of pre-existing user interface is any of the following:
a water-drop-like ripple effect;
a lens-like effect;
a burn-like effect;
a hole-like effect; and
a shake-like effect.

11. The method of claim 1, said presentation comprises any of the following:
an identification of the sender;
the sender username;
an image representing the sender;
an animated image representing the sender;
an artwork;
an animated artwork; and
a sound.

12. The method of claim 1, said presentation comprises an animation.

13. The method of claim 12, said animation is any of the following:
a twirl of each letter of said message;
a twirl of each word of said message;
a twirl at least part of said message;
a pop of each letter of said message;
a pop of each word of said message;
a pop at least part of said message;
a flip at least part of said message;
a color change at least part of said message; and
a transparency change at least part of said message.

14. The method of claim 12, said animation is selected by any of the following:
said recipient; and
said sender.

15. The method of claim 12, said animation is in relation to any of the following:
the length of said message; and
the content of said message.

16. The method of claim 1, the size of said presentation is in relation to any of the following:
the length of said message; and
the content of said message.

17. The method of claim 1, wherein an indication is provided to said recipient that a presentation of an incoming message is being delayed until a current presentation ends.

18. The method of claim 1, said transient message presentation being delayed until an action of said instant message recipient is performed.

19. The method of claim 1, wherein the client system that display said user interface for said instant messaging communications session is any of the following:
a desktop computer;
a portable computer;
a set-top box;
a game console;
a PDA; and
a cellular phone.

20. A computer implemented method, comprising the steps of:
providing an instant messaging client application user interface for an instant messaging communications session involving at least one instant message recipient and an instant message sender;
said at least one instant message recipient receiving a communication that comprises a message to be displayed to said at least one instant message recipient; and
said message being selected by said instant message sender;
wherein said message is presented magnified to said instant message sender while said instant message sender is selecting said message.

21. The method of claim 20, said selection is any of the following:
creation of said message; and
editing of said message.
